(19) United States
(12) Patent Application Publication
(10) Pub. No.: US 2024/0242358 A1
(43) Pub. Date: Jul. 18, 2024

(54) LOCAL MOTION DETECTION FOR IMPROVING IMAGE CAPTURE AND/OR PROCESSING OPERATIONS

(71) Applicant: QUALCOMM Incorporated, San Diego, CA (US)

(72) Inventors: Wen-Chun FENG, New Taipei City (TW); Wei-Chih LIU, Taipei City (TW); Mian LI, Shenzhen (CN); Ruocheng JIANG, Shenzhen (CN)

(21) Appl. No.: 18/563,254

(22) PCT Filed: Jul. 7, 2021
(86) PCT No.: PCT/CN2021/104915

§ 371 Date: Nov. 21, 2023

(51) Int. Cl. G06T 7/20; G06V 10/25; H04N 23/68

(52) U.S. Cl. CPC G06T 7/20; G06V 10/25; H04N 23/6812; H04N 23/682

(57) ABSTRACT

Techniques and systems are provided for improving one or more image capture operations. In some examples, a system determines, based on data from one or more sensors, a movement of an image capture device associated with a capture of a plurality of image frames. The systems adjust a position of at least one object in each of the plurality of image frames based on the movement of the image capture device. The system determines a motion of the at least one object based on a difference in the adjusted position among the plurality of image frames. The system selects a value for at least one image capture parameter associated with the plurality of image frames based on the motion of the at least one object.

### FIELD

This application is related to image processing. In some examples, aspects of this application relate to systems and techniques for improving image capture and/or image processing operations performed on image data.

### BACKGROUND

Cameras can be configured with a variety of image capture and image processing settings to alter the appearance of an image. Some image processing operations are determined and applied before or during capture of the photograph, such as auto-focus, auto-exposure, and auto-white-balance operations. These operations are configured to correct and/or alter one or more regions of an image (for example, to ensure the content of the regions is not blurry, over-exposed, or out-of-focus). The operations may be performed automatically by an image processing system or in response to user input. More advanced and accurate image processing techniques are needed to improve the output of image processing operations.

### SUMMARY

Systems and techniques are described herein for improving image capture and/or image processing operations (e.g., automatic-exposure algorithms, automatic-focus, automatic-white-balance, and related algorithms) performed on image data. According to at least one example, a method for processing image data is provided. The method can include: determining, based on data from one or more sensors, a movement of an image capture device associated with a capture of a plurality of image frames; adjusting a position of at least one object in each of the plurality of image frames based on the movement of the image capture device; determining a motion of the at least one object based on a difference in the adjusted position among the plurality of image frames; and selecting a value for at least one image capture parameter associated with the plurality of image frames based on the motion of the at least one object.

In another example, an apparatus for processing image data is provided. The apparatus includes at least one memory and one or more processors (e.g., configured in circuitry) coupled to the at least one memory. The one or more processors are configured to: determine, based on data from one or more sensors, a movement of an image capture device associated with a capture of a plurality of image frames; adjust a position of at least one object in each of the plurality of image frames based on the movement of the image capture device; determine a motion of the at least one object based on a difference in the adjusted position among the plurality of image frames; and select a value for at least one image capture parameter associated with the plurality of image frames based on the motion of the at least one object.

In another example, an apparatus for processing image data is provided that includes: means for determining, based on data from one or more sensors, a movement of an image capture device associated with a capture of a plurality of image frames; means for adjusting a position of at least one object in each of the plurality of image frames based on the movement of the image capture device; means for determining a motion of the at least one object based on a difference in the adjusted position among the plurality of image frames; and means for selecting a value for at least one image capture parameter associated with the plurality of image frames based on the motion of the at least one object.

In another example, a non-transitory computer-readable medium is provided having store thereon instructions that, when executed by one or more processors, cause the one or more processors to: determine, based on data from one or more sensors, a movement of an image capture device associated with a capture of a plurality of image frames; adjust a position of at least one object in each of the plurality of image frames based on the movement of the image capture device; determine a motion of the at least one object based on a difference in the adjusted position among the plurality of image frames; and select a value for at least one image capture parameter associated with the plurality of image frames based on the motion of the at least one object.

In some aspects, the one or more sensors include at least one of a gyroscope, an accelerometer, a magnetometer, and an inertial measurement unit (IMU).

In some aspects, the movement of the image capture device occurs during an exposure time corresponding to each of the plurality of image frames.

In some aspects, the method, apparatuses, and computer-readable medium described above further comprise: in response to determining that the movement of the image capture device is greater than a threshold value, selecting a default value for the at least one image capture parameter.

In some aspects, adjusting the position of the at least one object includes computing an electronic image stabilization (EIS) compensation.

In some aspects, to determine the motion of the at least one object, the method, apparatuses, and computer-readable medium described above further comprise: determining an optical flow between the plurality of image frames.

In some aspects, to determining the motion of the at least one object, the method, apparatuses, and computer-readable medium described above further comprise: determining a motion mask between a first image frame and a second image frame from the plurality of image frames.

In some aspects, the motion mask includes one or more motion vectors indicating a shift of at least one pixel between the first image frame and the second image frame.

In some aspects, the method, apparatuses, and computer-readable medium described above further comprise: determining a weighted table that includes one or more weight values corresponding to at least a portion of the one or more motion vectors.

In some aspects, the one or more weight values are selected based on a central region in the plurality of image frames.

In some aspects, the one or more weight values are selected based on a region of interest in the plurality of image frames.

In some aspects, a portion of the one or more weight values corresponding to an area outside the region of interest is set to zero.

In some aspects, the at least one image capture parameter includes at least one of an exposure time and a gain.

In some aspects, one or more of the apparatuses described above is or is part of a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a vehicle (e.g., a computing device of a vehicle), or other device. In some aspects, an apparatus includes a camera or multiple cameras for capturing one or more images. In some aspects, the apparatus further includes a display for displaying one or more images, notifications, and/or other displayable data. In some aspects, the apparatus can include one or more sensors, which can be used for determining a location and/or pose of the apparatus, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an example architecture of an image capture and processing system, in accordance with some examples;

FIG. 2 is a conceptual diagram illustrating operations of and interactions between components of an image processing system, in accordance with some examples;

FIG. 3 is a graph illustrating a relation between exposure time and motion magnitude, in accordance with some examples;

FIG. 4 is another conceptual diagram illustrating operations of and interactions between components of an image processing system, in accordance with some examples;

FIG. 5 is a flow diagram illustrating an example of a process for improving one or more image capture operations in image frames, in accordance with some examples;

FIG. 6 is a flow diagram illustrating another example of a process for improving one or more image capture operations in image frames, in accordance with some examples; and

FIG. 7 is a diagram illustrating an example of a system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the photograph, such as automatic-focus (also referred to as auto-focus), automatic-exposure (also referred to as auto-exposure), and automatic white-balance algorithms (also referred to as auto-while-balance), collectively referred to as “3A” or the “3As”. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

Images that are captured with a camera often include one or more objects that are moving. The movement of objects in an image can be referred to as local motion. Motion blur is the apparent streaking of moving objects in a photograph or a sequence of frames, such as film or animation. Motion blur occurs when the image changes during the recording of a single exposure, due to movement of objects (e.g., local motion) or long exposure. Algorithms that detect local motion (e.g., optical flow algorithms) can be used to minimize motion blur by adjusting parameters such as exposure time.

However, detecting local motion can be difficult when the camera itself experiences motion or movement (e.g., due to hand movement of user) while capturing an image. The movement of the camera while capturing an image can be referred to as global motion. Similar to local motion, global motion can result in motion blur in an image. In addition, global motion can hinder the algorithms that detect local motion because the global motion will shift all of the objects from one frame to the next, which will cause a static object to appear to be dynamic and will alter the motion of dynamic objects.

Accordingly, systems, apparatuses, processes (also referred to as methods), and computer-readable media (collectively referred to herein as “systems and techniques”) are described herein for improving the quality and/or efficiency of image processing operations. For instance, in some examples, the systems and techniques can minimize motion blur by using device sensors to detect global motion and adjust image frames based on the global motion. In some aspects, the systems and techniques can be used to estimate local motion magnitude while compensating for global motion in order to select an appropriate value for an image capture parameter (e.g., exposure time). Further aspects of the systems and techniques are described with respect to the figures.

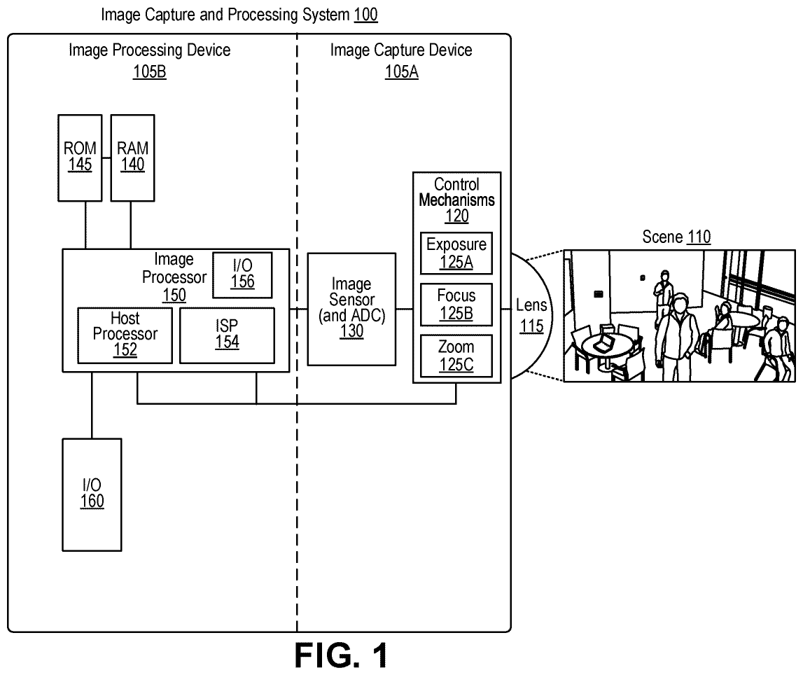

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties. In some cases, the one or more control mechanisms 120 may control and/or implement “3A” image processing operations.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 710 discussed with respect to the computing system 700. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/720, read-only memory (ROM) 145/725, a cache 712, a memory unit 715, another storage device 730, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 735, any other input devices 745, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Hose processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations (referred to as the “3As,” as noted above). In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

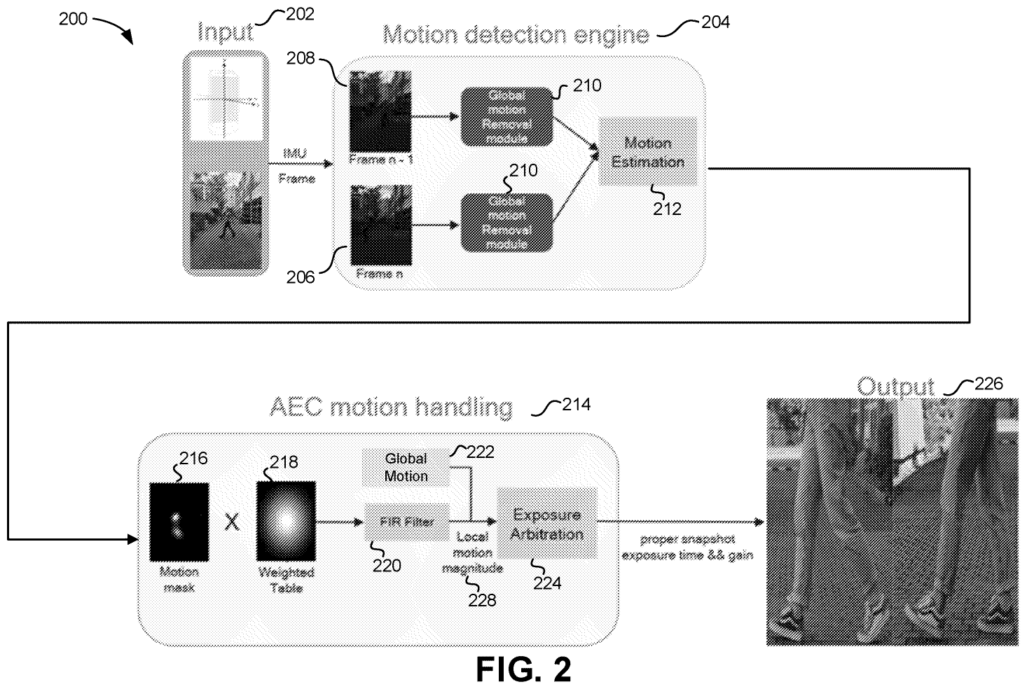

FIG. 2 is a conceptual diagram illustrating operations of and interactions between components of an image processing system 200. The image processing system 200 can include the components of the image capture and processing system 100 in some implementations. In some aspects, image processing system 200 can include a motion detection engine 204 and an Automatic Exposure Control (AEC) motion handling module 214. In some examples, the motion detection engine 204 can receive an input image 202 (e.g., image frame, frame, etc.), such as still images or video frames captured using an image sensor. In some cases, the motion detection engine 204 can separate or parse input image 202 into one or more frames, such as frame ‘n’ 206 and frame ‘n−1’ 208.

In some aspects, the motion detection engine 204 can include one or more global motion removal module(s) 210. In some examples, the global motion removal module 210 can process one or more image frames (e.g., frame ‘n’ 206 and/or frame ‘n−1’ 208) to compensate, adjust, and/or modify frame ‘n’ 206 and/or frame ‘n−1’ 208 for global motion (e.g., motion of camera caused by hand jitter). For instance, global motion removal module 210 can receive data from one or more sensors (not illustrated) that are configured to detect motion of the camera and/or of a device associated with the camera (e.g., mobile phone, tablet, computer, etc.). In some examples, the one or more sensors can include a gyroscope, an accelerometer, a magnetometer, an inertial measurement unit (IMU), any other device/sensor configured to detect motion, and/or any combination thereof. In some cases, the global motion can include rotational motion (e.g., pitch, roll, and yaw) and/or translational motion (e.g., in a horizontal or x-direction, in a vertical or y-direction, and in a depth or z-direction). In one illustrative example, an accelerometer can provide the translational motion and a gyroscope can provide the rotational motion.

In some cases, the global motion removal module 210 can use data from the one or more sensors to determine movement or motion of the camera that occurred during capture of frame ‘n’ 206 and/or frame ‘n−1’ 208. For example, global motion removal module 210 can determine movement or motion of the camera during an exposure time the corresponds to each frame (e.g., frame ‘n’ 206 and/or frame ‘n−1’ 208). In some aspects, global motion removal module 210 can implement electronic image stabilization (EIS) algorithms to remove global motion from frame ‘n’ 206 and/or frame ‘n−1’ 208. For instance, EIS algorithms can be used to shift frame ‘n’ 206 and/or frame ‘n−1’ 208 to remove global motion. In some aspects, motion detection engine 204 can implement EIS algorithms by using pixels outside the border of the visible frame to provide a buffer for the global motion. In some examples, EIS algorithms can reduce motion blur by smoothing the transition between frames (e.g., frame ‘n’ 206 and/or frame ‘n−1’ 208).

In some aspects, motion detection engine 204 can include a motion estimation module 212. In some examples, motion estimation module 212 can receive data from global motion removal module 210 that indicates or includes removal of global motion from frame ‘n’ 206 and/or frame ‘n−1’ 208. In some cases, motion estimation module 212 can be configured to detect local motion in one or more frames after global motion has been removed by global motion removal module 210. In some cases, local motion refers to movement of one or more objects during capture of an image frame (e.g., frame ‘n’ 206 and/or frame ‘n−1’ 208). For example, a subject that is running during capture of an image frame would cause local motion. In some cases, local motion can cause motion blur in an image frame. In some examples, adjustment of one or more image capture parameters (e.g., exposure time) can be used to compensate for local motion in order to eliminate or minimize motion blur caused by local motion.

In some examples, motion estimation module 212 can use an image-based method (e.g., optical flow algorithm) to determine local motion between two or more frames such as frame ‘n’ 206 and frame ‘n−1’ 208. In some aspects, motion estimation module 212 can determine one or more motion vectors that indicate or represent local motion between frame ‘n’ 206 and frame ‘n−1’ 208. For example, a motion vector can be used to indicate a change in position (e.g., movement indicated by direction and/or magnitude) of a pixel between frame ‘n’ 206 and frame ‘n−1’ 208. In some aspects, motion estimation module 212 can implement a sparse optical flow algorithm in which the motion estimation module 212 determines one or more motion vectors corresponding to the movement of a portion of the pixels between frame ‘n’ 206 and frame ‘n−1’ 208. In some examples, motion estimation module 212 can implement a dense optical flow algorithm in which the motion estimation module 212 determines one or more motion vectors corresponding to the movement of some or all pixels between frame ‘n’ 206 and frame ‘n−1’ 208. For instance, based on the dense optical flow, the motion estimation module 212 can determine an optical flow vector for each pixel in the frame ‘n’206, with each optical flow vector indicating a displacement in the horizontal or x-direction and a displacement in the vertical or y-direction of each pixel of frame ‘n’ 206 relative to the corresponding (or co-located) pixel of frame ‘n−1’ 208.

In some cases, motion estimation module 212 can generate or determine a motion mask 216 that can be provided to the AEC motion handling module 214. In some configurations, motion estimation module 212 can provide data corresponding to one or more motion vectors to the AEC motion handling module 214 and the AEC motion handling module 214 can generate or determine the motion mask 216. In some examples, the motion mask 216 can include one or more motion vectors indicating movement of pixels between frame ‘n’ 206 and frame ‘n−1’ 208. In some aspects, each of the motion vectors in motion mask 216 are associated with local motion between frame ‘n’ 206 and frame ‘n−1’ 208 after removal of global motion by global motion removal module 210.

In some aspects, the AEC motion handling module 214 can determine and/or include a weighted table 218 that can include one or more weights that can be used to implement a weight function. In some examples, weighted table 218 can be used to give one or more corresponding weight vectors additional weight or influence. In one illustrative example, AEC motion handling module 214 can select weight values in weight table 218 to focus on motion in a central region of frame ‘n’206. In another example, AEC motion handling module 214 can determine that multiple objects are associated with local motion and AEC motion handling module 214 can select weight values corresponding to a region of interest (ROI) associated with one of the objects. In some cases, the ROI can be selected to correspond to the largest object. In some examples, weight values that are outside of a ROI can be set to a default value such as zero. In some aspects, the average of the weights in weighted table 218 that are associated with a moving object can be one. In some examples, AEC motion handling module 214 and/or motion detection engine 204 can implement one or more artificial intelligence (AI) learning algorithms such as machine learning systems. For example, machine learning systems can be used to process motion mask 216 and determine weights for weighted table 218.

In some cases, AEC motion handling module 214 can include one or more filters such as finite impulse response (FIR) filter 220. In some examples, FIR filter 220 can be used to filter the output of one or more operations performed using motion mask 216 and weighted table 218. For instance, the product of motion mask 216 (e.g., one or more motion vectors) and weighted table 218 can be filtered using FIR filter 220.

In some aspects, the output of FIR filter 220 can correspond to local motion magnitude 228. In some examples, local motion magnitude 228 can correspond to a scalar that indicates the magnitude of local motion (e.g., a relative offset of pixels in an image) determined by AEC motion handling module 214. In some cases, local motion magnitude 228 can be determined based on motion mask 216 without application of weighted table 218 and/or FIR filter 220.

In some examples, local motion magnitude 228 and global motion data 222 can be provided as inputs to exposure arbitration module 224. In some cases, exposure arbitration module 224 can be configured to determine values for one or more parameters associated with capturing input image 202. For instance, exposure arbitration module 224 can be configured to determine values for exposure time, gain (e.g., signal amplification), gamma, and/or any other parameter that can be associated with local motion.

In some cases, global motion data 222 can include a global motion magnitude (e.g., determined by global motion removal module 210). In some examples, global motion data 222 can include sensor data used to determine global motion (e.g., gyroscope data, accelerometer data, etc.). In some aspects, exposure arbitration module 224 can determine an exposure time value based on global motion data 222. For example, exposure arbitration module 224 can determine that global motion data 222 is greater than a threshold value and can select a corresponding value based on the threshold. In one illustrative example, exposure arbitration module 224 can select an exposure time of 5.0 milliseconds (ms) when the global motion data 222 (e.g., magnitude of global motion) is greater than or equal to two (2).

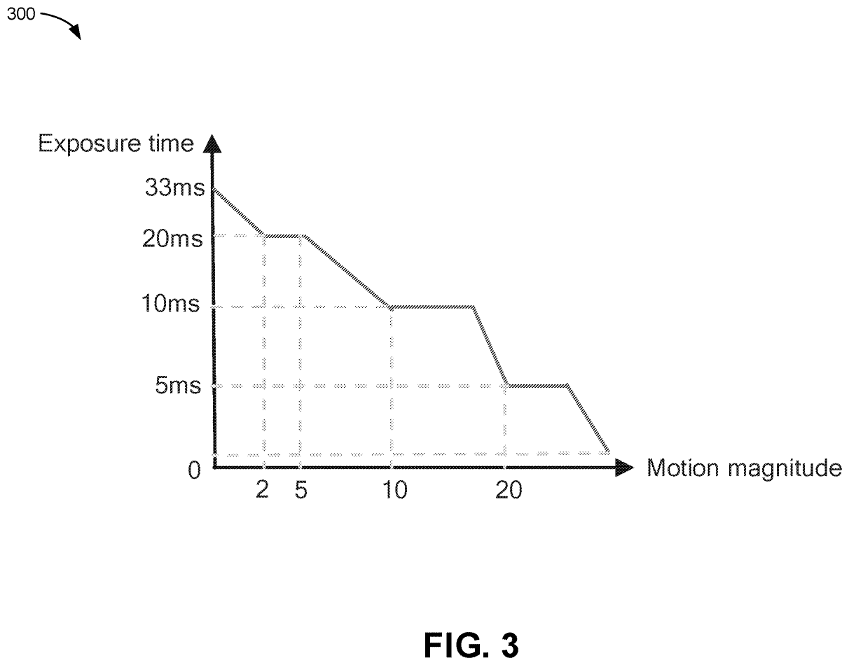

In some aspects, exposure arbitration module 224 can determine an exposure time value based on local motion magnitude 228. In some examples, the exposure time value can be inversely related to local motion magnitude 228. FIG. 3 is a graph 300 that illustrates a relation between exposure time values and local motion magnitude 228. For example, as illustrated in graph 300, exposure arbitration module 224 can select an exposure time value of 20 ms when local motion magnitude 228 has a value of 2. In another example illustrated in graph 300, exposure arbitration module 224 can select an exposure time value of 5 ms when local motion magnitude 228 has a value of 20. The relation between exposure time values and local motion magnitude 228 illustrated in graph 300 is provided for illustrative purposes, and those skilled in the art will recognize that different values and/or parameters can be implemented in accordance with the present technology.

In some examples, exposure arbitration module 224 can be configured to process input image 202 using one or more parameters that are determined based on global motion data 222 and local motion magnitude 228. In some aspects, exposure arbitration module can provide output image 226 that can be generated using the one or more parameters selected based on local motion magnitude 228 and/or global motion data 222. For example, output image 226 can be adjusted to have a different exposure time than input image 202 based on local motion magnitude 228.

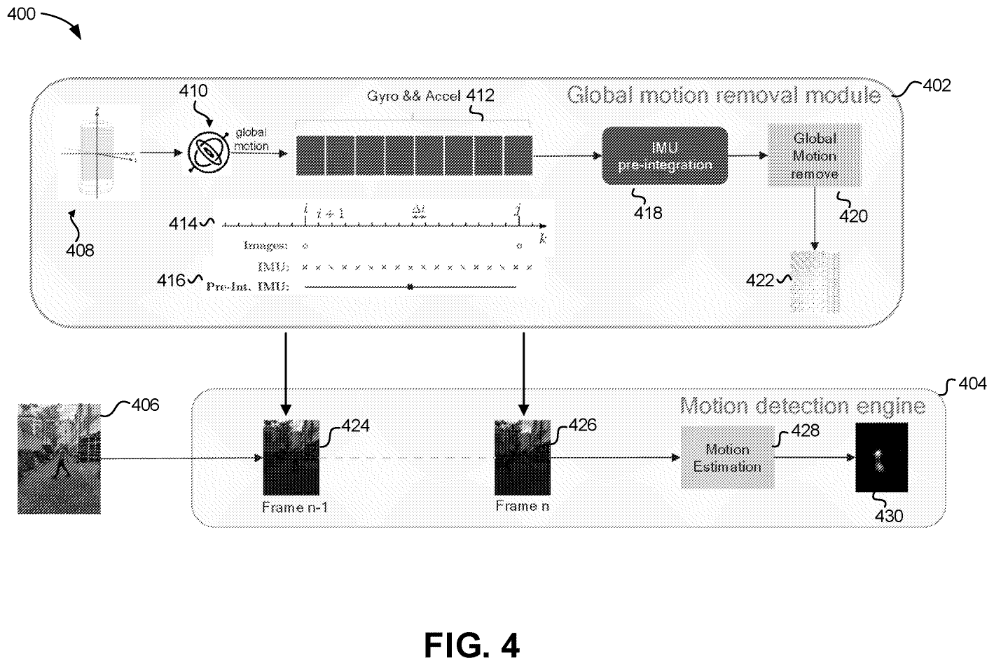

FIG. 4 is a conceptual diagram illustrating operations of and interactions between components of an image processing system 400. In some aspects, image processing system 400 can include global motion removal module 402 and motion detection engine 404. In some examples, image processing system 400 can be configured to process input image 406 by identifying and removing global motion in order to identify effective local motion. In some cases, the local motion (e.g., determined after accounting for global motion) can be used to determine one or more parameters that can be used to adjust input image 406 (e.g., to minimize or reduce motion glare).

In some aspects, global motion removal module 402 can include or be coupled to one or more motion sensors 408. In some examples, the one or more motion sensors 408 can include a gyroscope, an accelerometer, a magnetometer, an inertial measurement unit (IMU), and/or any other sensor that can be configured to measure movement or position of a camera. In some aspects, global motion removal module 402 can obtain or determine global motion data 410 (e.g., from motion sensors 408) that can include data associated with movement of the camera while capturing input image 406.

In some examples, global motion removal module 402 can correlate global motion data 410 with one or more frames (e.g., frame ‘n−1’ 424 and/or frame ‘n’ 426) corresponding to input image 406. For example, gyroscope and/or accelerometer data 412 can be parsed to correspond to one or more time intervals 414. In some aspects, global motion removal module 402 can calculate a device rotation vector and/or a device translation vector based on global motion data 410. In some examples, the time intervals 414 can correspond to an exposure time for capturing each frame.

In some aspects, global motion removal module 402 can include an IMU pre-integration module 418. In some examples, IMU pre-integration module 418 can be used to determine the global motion associated with each frame corresponding to input image 406. In some cases, IMU pre-integration module 418 can implement electronic image stabilization (EIS) algorithms to determine global motion. In some aspects, IMU pre-integration module 418 can process and filter gyroscope and/or accelerometer data 412 to identify one or more data points corresponding to one or more frames. For example, graphical representation 416 illustrates a series of ‘x’ symbols corresponding to IMU data in a time sequence (e.g., based on sampling rate) and a single Pre-Int. IMU data point corresponding to an average speed (e.g., as calculated by IMU pre-integration module 418). In some cases, IMU pre-integration module 418 can determine global motion by calculating a rotation vector R, a speed v, and/or a position vector p using one or more of the following equations:

$$R ( t + Δ t ) = R ( t ) Exp ( ( \text{?} ( t ) - {b}^{g} ( t ) - {η}^{gd} ( t ) ) ) Δ t )$$

$$v ( t + Δ t ) = v ( t ) + g Δ t + R ( t ) ( \text{?} ( t ) - \text{?} ( t ) - \text{?} ( t ) ) Δ t$$

$$p ( t + Δ t ) = p ( t ) + v ( t ) Δ t + \frac{1}{2} g Δ {t}^{2} + \frac{1}{2} R ( t ) ( \text{?} ( t ) - \text{?} ( t ) - \text{?} ( t ) ) Δ {t}^{2} \text{?}$$

$$\text{?} \text{indicates text missing or illegible when filed}$$

In some aspects, the variables in the foregoing equations are defined as follows:
ω—angular speed
b^{g}—gyro error bias
η—gaussian white noise
g—acceleration of gravity
a—accelerated velocity
b^{a}—accel error bias
R—rotation vector
v—speed
P—position vector

In some examples, the output of IMU pre-integration module 418 can be provided to a global motion remove module 420. In some aspects, the global motion remove module 420 can provide global motion data 422 that can be used to adjust the position of one or more objects in frame ‘n−1’ 424 and frame ‘n’ 426. In some examples, global motion data 422 can be used to remove and/or compensate for global motion for each frame (e.g., frame ‘n−1’ 424 and frame ‘n’ 426) prior processing the frames to detect local motion.

In some aspects, motion detection module 404 can determine local motion by using an image-based algorithm (e.g., optical flow algorithm). For example, motion detection module 404 can determine one or more motion vectors indicating a direction and a magnitude of movement for one or more of the pixels in frame ‘n−1’ 424 and frame ‘n’ 426. In some examples, motion detection engine can include a motion estimation module 428 that can be configured to detect local motion of objects between frames and provide motion mask 430. In some cases, motion mask 430 can correspond to motion mask 216 as discussed with respect to FIG. 2.

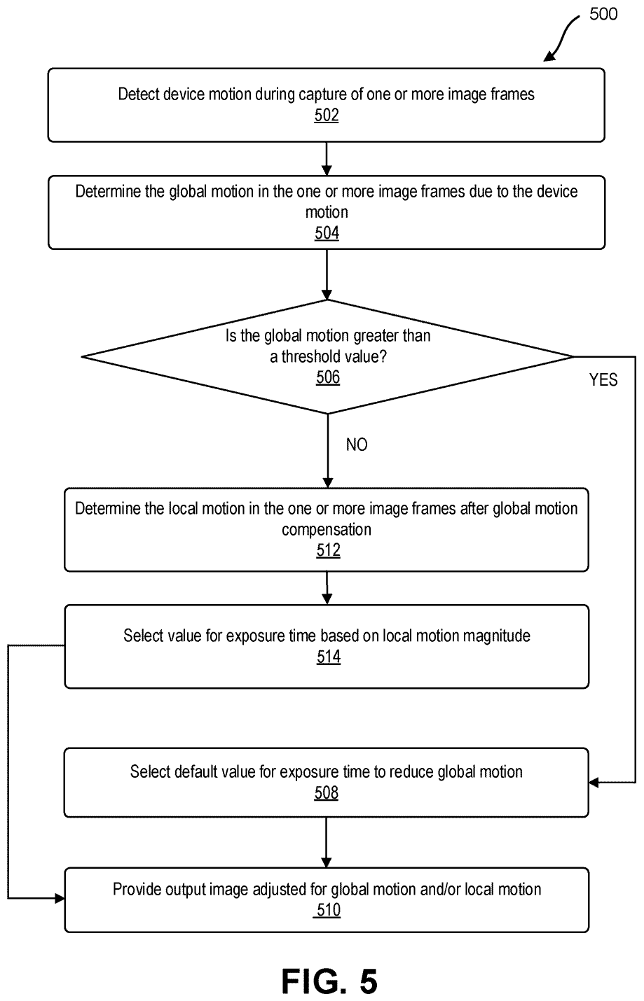

FIG. 5 is a flow diagram illustrating an example process 500 for improving one or more image processing operations. At block 502, the process 500 includes detecting device motion during capture of one or more image frames. In some aspects, device motion can be detected using one or more sensors associated with the device or camera, such as a gyroscope, accelerometer, magnetometer, and/or inertial measurement unit (IMU). In some examples, device motion can result in global motion in an image or frame. For example, hand movement or jitter by a user can cause stationary objects to appears as though in motion (e.g., global motion). Global motion can adversely affect algorithms that are intended to compensate for local motion (e.g., actual movement of objects between frames).

At block 504, the process 500 includes determining the global motion in the one or more image frames due to the device motion. In some examples, global motion can be determined using electronic image stabilization (EIS) algorithms. In some aspects, global motion can be determined based on a time interval associated with a particular frame. For example, global motion can be determined based on a time interval corresponding to the exposure time for capturing a frame. In some cases, determining global motion can include determining a device rotation vector and/or a device translation vector (e.g., based on sensor data).

At block 506, the process 500 includes determining whether the global motion value is greater than a threshold value. In some examples, the threshold value can correspond to a high level of global motion that can be associated with a minimum exposure time. If the global motion value is greater than a threshold value, the process 500 can proceed to block 508. At block 508, the process 500 includes selecting a default value for exposure time in order to reduce global motion. In some cases, the default value can correspond to a minimum exposure time that is selected based on the global motion threshold value. In some aspects, the minimum exposure time value can be selected based on global motion and can be independent of local motion. For instance, a minimum exposure time of 5.0 milliseconds (ms) can be selected when the global motion is greater than or equal to two (2).

In some examples, if the global motion value is not greater than a threshold value, the process 500 can proceed to block 512. At block 512, the process 500 includes determining the local motion in the one or more image frames after global motion compensation. In some aspects, determining local motion can include determining motion vectors as between image frames that have been adjusted to remove global motion. In some cases, motion vectors can indicate movement of a pixel from a first image frame to a second image frame. In some examples, the weights of motion vectors can be adjusted using a weight table. For instance, a weight table can be configured to focus on movement of objects in a particular region of interest.

At block 514, the process 500 includes selecting a value for exposure time based on the local motion magnitude. In some aspects, the exposure time can be selected to minimize motion blur due to local motion. In some examples, the exposure time can have an inverse relationship to the local motion magnitude (see, e.g., graph 300 in FIG. 3).

At block 510, the process 500 includes providing an output image adjusted for global motion and/or local motion. In some examples, the output image can be provided using an exposure time that is selected based on the magnitude of the local motion. In some aspects, the output image can be provided using an exposure time that is selected based on the magnitude of the global motion. In some cases, the output image can have an improved image quality with reduced motion blur caused by global motion and/or local motion.

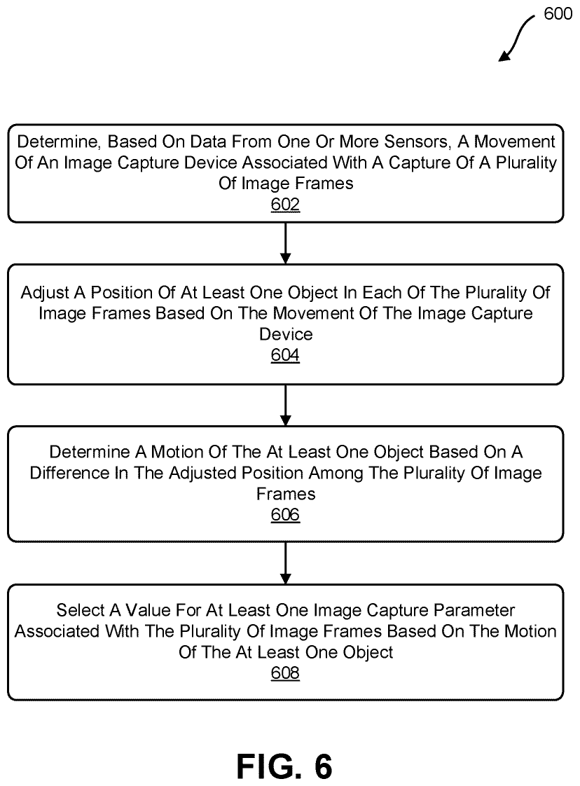

FIG. 6 is a flow diagram illustrating an example process 600 for improving one or more image processing operations in image frames. At block 602, the process 600 includes determining, based on data from one or more sensors, a movement of an image capture device associated with a capture of a plurality of image frames. In some examples, the one or more sensors can include at least one of a gyroscope, an accelerometer, a magnetometer, and an inertial measurement unit (IMU). In some aspects, the movement of the image capture device can occur during an exposure time corresponding to each of the plurality of image frames. For example, global motion removal module 402 can use data from motion sensors 408 to determine movement of a camera during capture of frame ‘n−1’ 424 and/or frame ‘n’ 426.

At block 604, the process 600 includes adjusting a position of at least one object in each of the plurality of image frames based on the movement of the image capture device. In some aspects, adjusting the position of the at least one object includes computing an electronic image stabilization (EIS) compensation. For example, motion detection engine 204 can adjust a position of at least one object in each of frame ‘n−1’ 208 and frame ‘n’ 206 by implementing an EIS algorithm.

At block 606, the process 600 includes determining a motion of the at least one object based on a difference in the adjusted position among the plurality of image frames. In some examples, determining the motion of the at least one object includes determining an optical flow between the plurality of image frames. In some aspects, determining the motion of the at least one object includes determining a motion mask between a first image frame and a second image frame from the plurality of image frames. In some cases, the motion mask includes one or more motion vectors indicating a shift of at least one pixel between the first image frame and the second image frame.

For example, motion detection engine 204 can determine a local motion of at least one object based on a difference in the adjusted position (e.g., compensated for global motion) among frame ‘n’ 206 and frame ‘n−1’ 208. In some aspects, motion detection engine 204 can determine an optical flow between frame ‘n’ 206 and frame ‘n−1’ 208. In some examples, motion detection engine 204 and/or AEC motion handling module 214 can determine motion mask 216. In some aspects, motion mask 216 can include one or more motion vectors indicating a shift of at least one pixel between frame ‘n’ 206 and frame ‘n−1’ 208.

At block 608, the process 600 includes selecting a value for at least one image capture parameter associated with the plurality of image frames based on the motion of the at least one object. In some examples, the at least one image capture parameter includes at least one of an exposure time and a gain. For instance, exposure arbitration module 224 can determine an image capture parameter based on global motion data 222 and/or local motion magnitude 228. In some aspects, a default value can be selected for the at least one image capture parameter in response to determining that the movement of the image capture device is greater than a threshold value. For example, exposure arbitration module 224 can select a default exposure time if global motion data 222 is greater than or equal to a threshold value.

In some examples, the process can include determining a weighted table that includes one or more weight values corresponding to at least a portion of the one or more motion vectors. In some aspects, the one or more weight values are selected based on a central region in the plurality of image frames. In some cases, the one or more weight values are selected based on a region of interest (ROI) in the plurality of image frames. In some cases, a portion of the one or more weight values corresponding to an area outside the region of interest is set to zero. For instance, AEC motion handling module 214 can determine weighted table 218 that can include one or more weights that can be used to implement a weight function. In some examples, weighted table 218 can be used to give one or more corresponding weight vectors additional weight or influence. In one illustrative example, AEC motion handling module 214 can select weight values in weight table 218 to focus on motion in a central region of frame ‘n’ 206. In another example, AEC motion handling module 214 can determine that multiple objects are associated with local motion and AEC motion handling module 214 can select weight values corresponding to a region of interest (ROI) associated with one of the objects.

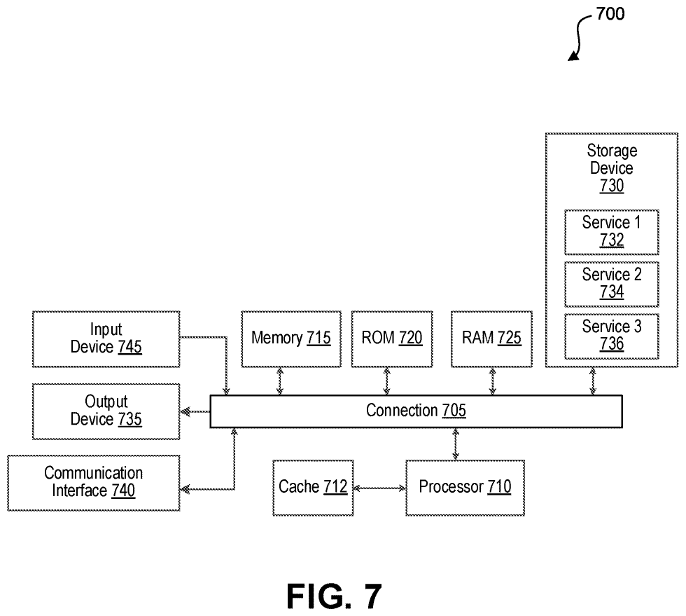

In some examples, the processes described herein (e.g., process 500, process 600 and/or other process described herein) may be performed by a computing device or apparatus. In one example, the process 500 and/or the process 600 can be performed by the image processing and capture system 100 of FIG. 1. In another example, the process 500 and/or the process 600 can be performed by a computing device with the computing system 700 shown in FIG. 7. For instance, a computing device with the computing architecture shown in FIG. 7 can include the components of the image processing and capture system 100 and can implement the operations of FIG. 5 and FIG. 6.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 800. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 500 and the process 600 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 500, the process 600, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 is a diagram illustrating an example of a system for implementing certain aspects of the present technology. In particular, FIG. 7 illustrates an example of computing system 700, which can be for example any computing device making up internal computing system, a remote computing system, a camera, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including the memory unit 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processyu76ytor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Aspect 1: An apparatus for processing image data including at least one memory and one or more processors (e.g., configured in circuitry) coupled to the at least one memory. The one or more processors are configured to: determine, based on data from one or more sensors, a movement of an image capture device associated with a capture of a plurality of image frames; adjust a position of at least one object in each of the plurality of image frames based on the movement of the image capture device; determine a motion of the at least one object based on a difference in the adjusted position among the plurality of image frames; and select a value for at least one image capture parameter associated with the plurality of image frames based on the motion of the at least one object.

Aspect 2: The apparatus of aspect 1, wherein the one or more sensors include at least one of a gyroscope, an accelerometer, a magnetometer, and an inertial measurement unit (IMU).

Aspect 3: The apparatus of any of aspects 1 or 2, wherein the movement of the image capture device occurs during an exposure time corresponding to each of the plurality of image frames.

Aspect 4: The apparatus of any of aspects 1 to 3, wherein the processor is further configured to: in response to determining that the movement of the image capture device is greater than a threshold value, select a default value for the at least one image capture parameter.

Aspect 5: The apparatus of any of aspects 1 to 4, wherein the processor is configured to adjust the position of the at least one object based on computing an electronic image stabilization (EIS) compensation.

Aspect 6: The apparatus of any of aspects 1 to 5, wherein the processor is configured to determine the motion of the at least one object based on determining an optical flow between the plurality of image frames.

Aspect 7: The apparatus of any of aspects 1 to 6, wherein the processor is configured to determine the motion of the at least one object based on determining a motion mask between a first image frame and a second image frame from the plurality of image frames.

Aspect 8: The apparatus of aspect 7, wherein the motion mask includes one or more motion vectors indicating a shift of at least one pixel between the first image frame and the second image frame.

Aspect 9: The apparatus of any of aspects 7 or 8, wherein the processor is further configured to: determine a weighted table that includes one or more weight values corresponding to at least a portion of the one or more motion vectors.

Aspect 10: The apparatus of aspect 9, wherein the one or more weight values are selected based on a central region in the plurality of image frames.

Aspect 11: The apparatus of any of aspects 9 or 10, wherein the one or more weight values are selected based on a region of interest in the plurality of image frames.

Aspect 12: The apparatus of aspect 11, wherein a portion of the one or more weight values corresponding to an area outside the region of interest is set to zero.

Aspect 13: The apparatus of any of aspects 1 to 12, wherein the at least one image capture parameter includes at least one of an exposure time and a gain.

Aspect 14: A method of processing image data, including: determining, based on data from one or more sensors, a movement of an image capture device associated with a capture of a plurality of image frames; adjusting a position of at least one object in each of the plurality of image frames based on the movement of the image capture device; determine a motion of the at least one object based on a difference in the adjusted position among the plurality of image frames; and selecting a value for at least one image capture parameter associated with the plurality of image frames based on the motion of the at least one object.

Aspect 15: The method of aspect 14, wherein the one or more sensors include at least one of a gyroscope, an accelerometer, a magnetometer, and an inertial measurement unit (IMU).

Aspect 16: The method of any of aspects 14 or 15, wherein the movement of the image capture device occurs during an exposure time corresponding to each of the plurality of image frames.

Aspect 17: The method of any of aspects 14 to 16, further comprising: in response to determining that the movement of the image capture device is greater than a threshold value, selecting a default value for the at least one image capture parameter.

Aspect 18: The method of any of aspects 14 to 17, further comprising: adjusting the position of the at least one object based on computing an electronic image stabilization (EIS) compensation.

Aspect 19: The method of any of aspects 14 to 18, further comprising: determining the motion of the at least one object based on determining an optical flow between the plurality of image frames.

Aspect 20: The method of any of aspects 14 to 19, further comprising: determining the motion of the at least one object based on determining a motion mask between a first image frame and a second image frame from the plurality of image frames.

Aspect 21: The method of aspect 20, wherein the motion mask includes one or more motion vectors indicating a shift of at least one pixel between the first image frame and the second image frame.

Aspect 22: The method of any of aspects 20 or 21, further comprising: determining a weighted table that includes one or more weight values corresponding to at least a portion of the one or more motion vectors.

Aspect 23: The method of aspect 22, wherein the one or more weight values are selected based on a central region in the plurality of image frames.

Aspect 24: The method of any of aspects 22 or 23, wherein the one or more weight values are selected based on a region of interest in the plurality of image frames.

Aspect 25: The method of aspect 24, wherein a portion of the one or more weight values corresponding to an area outside the region of interest is set to zero.

Aspect 26: The method of any of aspects 14 to 25, wherein the at least one image capture parameter includes at least one of an exposure time and a gain.

Aspect 27: A computer-readable storage medium storing instructions that, when executed, cause one or more processors to perform any of the operations of aspects 1 to 26.

Aspect 28: An apparatus comprising means for performing any of the operations of aspects 1 to 26.

1. A method for processing image data, the method comprising:
determining, based on data from one or more sensors, a movement of an image capture device associated with a capture of a plurality of image frames;
adjusting a position of at least one object in each of the plurality of image frames based on the movement of the image capture device;
determining a motion of the at least one object based on a difference in the adjusted position among the plurality of image frames; and
selecting a value for at least one image capture parameter associated with the plurality of image frames based on the motion of the at least one object.

2. The method of claim 1, wherein the one or more sensors include at least one of a gyroscope, an accelerometer, a magnetometer, and an inertial measurement unit (IMU).

3. The method of claim 1, wherein the movement of the image capture device occurs during an exposure time corresponding to each of the plurality of image frames.

4. The method of claim 1, further comprising:
in response to determining that the movement of the image capture device is greater than a threshold value, selecting a default value for the at least one image capture parameter.

5. The method of claim 1, wherein adjusting the position of the at least one object includes computing an electronic image stabilization (EIS) compensation.

6. The method of claim 1, wherein determining the motion of the at least one object includes determining an optical flow between the plurality of image frames.

7. The method of claim 1, wherein determining the motion of the at least one object includes determining a motion mask between a first image frame and a second image frame from the plurality of image frames.

8. The method of claim 7, wherein the motion mask includes one or more motion vectors indicating a shift of at least one pixel between the first image frame and the second image frame.

9. The method of claim 8, further comprising:
determining a weighted table that includes one or more weight values corresponding to at least a portion of the one or more motion vectors.

10. The method of claim 9, wherein the one or more weight values are selected based on a central region in the plurality of image frames.

11. The method of claim 9, wherein the one or more weight values are selected based on a region of interest in the plurality of image frames.

12. The method of claim 11, wherein a portion of the one or more weight values corresponding to an area outside the region of interest is set to zero.

13. The method of claim 1, wherein the at least one image capture parameter includes at least one of an exposure time and a gain.

14. An apparatus for processing image data, the apparatus comprising:
a memory:
a processor configured to:
determine, based on data from one or more sensors, a movement of an image capture device associated with a capture of a plurality of image frames;
adjust a position of at least one object in each of the plurality of image frames based on the movement of the image capture device;
determine a motion of the at least one object based on a difference in the adjusted position among the plurality of image frames; and
select a value for at least one image capture parameter associated with the plurality of image frames based on the motion of the at least one object.

15. The apparatus of claim 14, wherein the one or more sensors include at least one of a gyroscope, an accelerometer, a magnetometer, and an inertial measurement unit (IMU).

16. The apparatus of claim 14, wherein the movement of the image capture device occurs during an exposure time corresponding to each of the plurality of image frames.

17. The apparatus of claim 14, wherein the processor is further configured to:
in response to determining that the movement of the image capture device is greater than a threshold value, select a default value for the at least one image capture parameter.

18. The apparatus of claim 14, wherein the processor is configured to adjust the position of the at least one object based on computing an electronic image stabilization (EIS) compensation.

19. The apparatus of claim 14, wherein the processor is configured to determine the motion of the at least one object based on determining an optical flow between the plurality of image frames.

20. The apparatus of claim 14, wherein the processor is configured to determine the motion of the at least one object based on determining a motion mask between a first image frame and a second image frame from the plurality of image frames.

21. The apparatus of claim 20, wherein the motion mask includes one or more motion vectors indicating a shift of at least one pixel between the first image frame and the second image frame.

22. The apparatus of claim 21, wherein the processor is further configured to:
determine a weighted table that includes one or more weight values corresponding to at least a portion of the one or more motion vectors.

23. The apparatus of claim 22, wherein the one or more weight values are selected based on a central region in the plurality of image frames.

24. The apparatus of claim 22, wherein the one or more weight values are selected based on a region of interest in the plurality of image frames.

25. The apparatus of claim 24, wherein a portion of the one or more weight values corresponding to an area outside the region of interest is set to zero.

26. The apparatus of claim 14, wherein the at least one image capture parameter includes at least one of an exposure time and a gain.

27. (canceled)

28. (canceled)
